(19) United States
(12) Patent Application Publication
(10) Pub. No.: US 2003/0148242 A1
(43) Pub. Date: Aug. 7, 2003

(54) Lightweight hand held dental curing device

(76) Inventors: Dan E. Fischer, Sandy, UT (US); Bruce S. McLean, Sandy, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/068,103

(22) Filed: Feb. 5, 2002

(51) Int. Cl. A61C 3/00

(52) U.S. Cl. 433/29

(57) ABSTRACT

A dental device configured for curing light-curable compounds includes a slender body having the general configuration of a dental hand piece. The dental device is equipped with finger controls for controlling the emission of light from an LED light source disposed at the distal end of the dental device. The LED light source may include transilluminating lenses for filtering out undesired radiant energy. A remote power supply connected with the dental device provides power to the dental device without increasing the size or weight of the dental device. The body of the dental device is specifically configured for being securely held within the holding slot of a standard dental tray used for holding dental hand pieces.

### BACKGROUND OF THE INVENTION

1. The Field of the Invention

The present invention generally relates to the field of light-curing devices and, more specifically, to handheld dental light-curing devices incorporating LED light sources.

2. The Relevant Technology

In the field of dentistry, dental cavities are often filled and/or sealed with photosensitive compounds that are cured when they are exposed to radiant energy, such as visible light. These compounds, commonly referred to as light-curable compounds, are placed within dental cavity preparations or onto dental surfaces where they are subsequently irradiated by a light-curing dental device.

Many light-curing devices are configured with a fiber optic light guide for directing light from a light source into a patient's mouth. The light source may comprise, for example, a lamp, a halogen bulb or a light-emitting diode (LED). One end of the light guide is placed close to the light source so that the light emitted from the light source will be directed into and captured by the light guide. One problem with light guides, however, is that they are relatively heavy and can significantly increase the weight of the light-curing device. This is particularly true when the light guide is composed of a relatively heavy material, such as glass. Light guides also indirectly increase the weight of the light-curing devices, in as much as light-curing devices incorporating light guides often require special reflector assemblies for focusing the desired light into the light guides that can increase the weight of the light-curing devices. Yet another feature that can increase the weight of the light-curing devices is the power supply, such as a battery pack or a transformer for alternating current (AC).

The additional weight of the light-curing devices that is directly or indirectly caused by the light-guide and power supply can make it difficult to manipulate the light-curing device within an operator's hand. Weight can also increase the cost of shipping and hence the overall cost of the device.

Light-guides and integrated power supply units also add bulk to the light-curing devices, thereby increasing the difficulty of gripping and manipulating the light-curing devices by hand. The bulky size of certain existing light-curing devices is also problematic because the bulky size generally prevents the light-curing devices from being held or stored within the holding slots of existing dental hand piece holding trays, which are designed to hold standard dental hand pieces such as ultrasonic tools, three-way syringes, suctioning devices and high and low speed turbines, and the like. Because existing dental light-curing devices are generally too bulky to be securely held within the holding slots of a dental hand piece holding tray, they must be set on a counter or another surface during periods of non-use. It will be appreciated that this, along with the increased weight of the light-curing device, significantly increases the probability of the light-curing device being accidentally dropped or knocked onto the floor.

Accordingly, in view of the foregoing, there is currently a need in the art for improved dental light-curing devices and, more particularly, to dental light-curing devices ergonomically configured in size, shape and weight for ease of use and for storage within standard dental hand piece holding trays.

### SUMMARY OF PRESENTLY PREFERRED EMBODIMENTS

Briefly summarized, presently preferred embodiments of the present invention are directed to improved dental devices configured for curing light-curable compounds. More particularly, the presently preferred embodiments of the present invention are directed to light-curing devices ergonomically configured into the general shape of standard dental hand pieces for ease of use and for facilitating storage in a dental hand piece holding tray during non-use.

According to one presently preferred embodiment, the dental devices comprise a body extending between a proximal end and a distal end. The body is configured in size, shape and weight to look and feel like a standard dental hand piece and to fit securely within the holding slot of a standard dental hand piece holding tray.

A light source disposed at the distal end of the body emits light from the dental device for predetermined durations when controls on the dental device are manipulated. The controls may include, for example, a button for activating the light source a predetermined duration of time and buttons for increasing and decreasing the duration of time the light source is activated each time the light source is activated. The light source may comprise any light source configured to provide radiant energy. According to one embodiment, the light source comprises at least one LED.

The dental device may also include a filter, such as a transilluminating lens, that is placed over the light source. The transilluminating lens may be color tinted for filtering out certain unnecessary wavelengths, such as orange, green, or yellow spectrum light generated by the light source. The transilluminating lens can also function as a protective shield for protecting the light source from contaminating elements in the dental environment.

According to one embodiment, the dental device further comprises a power cord configured to operably connect the dental device with an external power supply, such as an electrical wall socket or an AC/DC converter.

The dental device may also be included as part of a kit that further includes a holder configured to be connected to a dental hand piece holding tray or other device. This embodiment can be particularly useful when the dental device and holder are connected with unconventional or nonstandard dental holding trays because the holder can be customized to fit any desired dental holding tray.

It will be appreciated that the general configuration of the dental devices of the invention are both ergonomic and light weight, thereby enabling the dental device to be handled with minimal effort and for enabling the dental device to be easily stowed away within the holding slot of a dental hand piece holding tray during periods of non-use.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a bottom perspective view of one embodiment of the dental device of the invention that includes a slender body configured in the general shape and size of a dental hand piece, extending from a proximal end to a distal end, with an LED light source disposed at the distal end and a power cord connected at the proximal end;

FIG. 2 illustrates a top perspective view of one embodiment of the dental device of FIG. 1 that further illustrates controls disposed on a protrusion of the body configured for controlling the illumination of the light source;

FIG. 3 illustrates a top perspective view of the dental device of FIG. 1 and of a holding slot configured to securely hold the dental device when the dental device is placed within the holding slot; and

FIG. 4 illustrates a light-curing device according to the invention received within a conventional dental hand piece holding tray.

### DETAILED DESCRIPTION OF THE PREFERRED EMBODIMENTS

A detailed description of the dental device of the invention will now be provided with specific reference to figures illustrating preferred embodiments of the invention. It will be appreciated that like structures will be provided with like reference designations.

The term “dental hand piece,” as used herein, generally refers to a handheld dental device that engages rotary instruments for cutting, cleaning, polishing or otherwise treating teeth. The term “dental hand piece” is a term of art well known in the dental industry. Nonlimiting examples of dental hand pieces include high speed turbines, low speed turbines, ultrasonic devices, and 3-way syringes. Dental hand pieces are typically driven by pneumatic, electric, and ultrasonic mechanisms.

The term “dental hand piece holding tray” generally refers to a tray configured with slots or holding devices specifically configured in shape and size for holding conventional dental hand pieces. Dental hand piece holding trays, which are well-known to those skilled in the art, are placed proximate or mounted directly to dental chairs for facilitating access to dental hand pieces held by the holding trays.

The terms “holding slot” and “holder,” which are used interchangeably herein, generally refer to devices configured in size and shape to securely hold a dental hand piece. A holding slot is a typical feature of a dental hand piece holding tray.

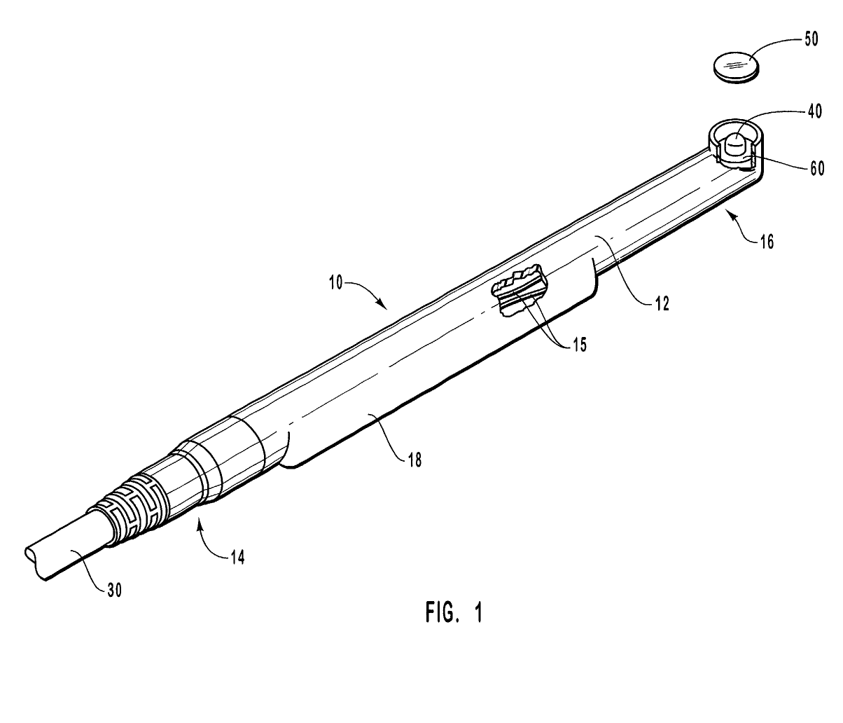

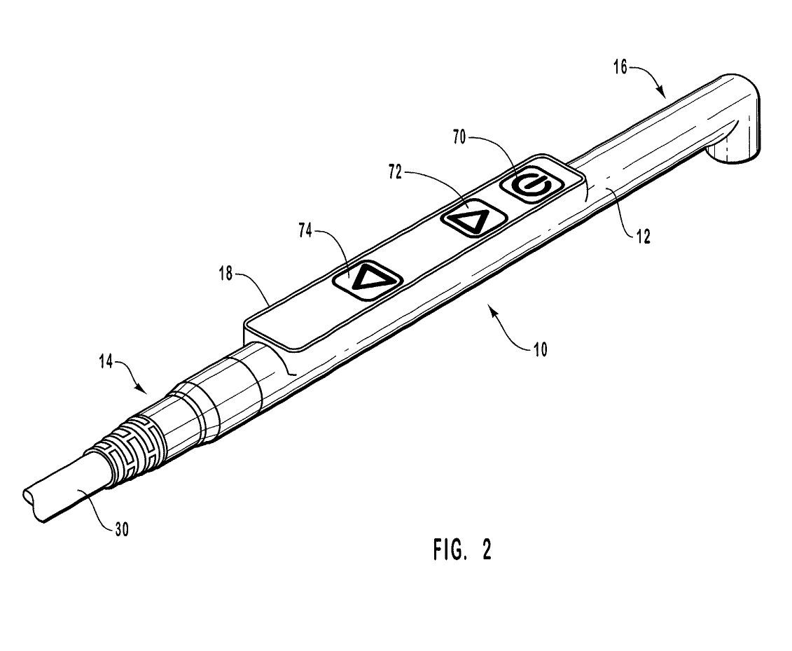

Reference is first made to FIG. 1, which illustrates one preferred embodiment of the dental device of the invention. As shown, the dental device 10 has the general configuration of a dental hand piece with a sleek and slender body 12 that extends from a proximal end 14 to a distal end 16. The shape of the body 12 is generally cylindrical, being defined by a circular cross-sectional shape. It will be appreciated, however, that the cross-sectional shape of the body 12 may be configured into other shapes, including, but not limited to, square, triangular, hexagonal, oval, and rectilinear shapes. The body 12 may also include small or slight irregularities or protrusions such as protrusion 18, which is configured with control buttons for controlling the operation of the dental device 10, as described below in reference to FIG. 2.

The generally cylindrical shape of the dental device 10 is useful, in the present embodiment, because it is ergonomic. In particular, the generally cylindrical shape of the body 12 enables a dental practitioner to comfortably hold the dental device in various positions. The sleek and slender body 12 of the dental device is also useful for enabling the dental practitioner to easily rotate and move the dental device 10 into various positions during a dental procedure.

According to one embodiment, the proximal end 14 of the dental device 10 is configured in size and shape to be inserted into the holding slot of a dental hand piece holding tray. The proximal end 14 of the body 12 may also be tapered to facilitate insertion of the dental device 10 into a holding slot. Placing the dental device 10 within a holding slot of a dental hand piece holding tray during a dental procedure can be useful for minimizing any chance for the dental device 10 to be accidentally knocked or dropped during periods of nonuse.

As shown, the dental device 10 is also configured to be connected with a power cord 30 at the proximal end 14 of the body 12. Although not shown, the power cord 30 operably connects the dental device 10 with a power supply remotely located away from the dental device 10. The remote power supply may include an electrical wall receptacle, a battery pack, a generator, a transformer, or any other power supply suitably configured for providing an appropriate supply of power to the dental device for illuminating the light source 40 of the dental device 10, which is disposed at the distal end 16 of the dental device 10. Power supply wires 15 communicating between the power supply cord 30 and the light source 40 are advantageously disposed within, and protectively, the body 12.

According to one embodiment, the light source 40 includes an LED configured to emit radiant energy that is suitable for curing light curable compounds. It will be appreciated, however that the light source 40 may also include an LED array, a plurality of LEDs, and other similar light sources. Lens, filters and the like may be used in conjunction with the light source 40.

In particular, the dental devices 10 of the present invention may include external filters or lenses for covering the LED light source 40 for performing a desired optical effect on the light that is emitted from the light source 40, such as for example, focusing or filtering light emitted by the light source 40.

U.S. Pat. No. 6,331,111, issued to Cao, which is incorporated herein by reference, discloses light curing devices having one or more light sources disposed at a distal end, which are powered by a remotely located power supply. The light curing devices disclosed in Cao, however are not configured into the general shape and size of a conventional dental hand piece.

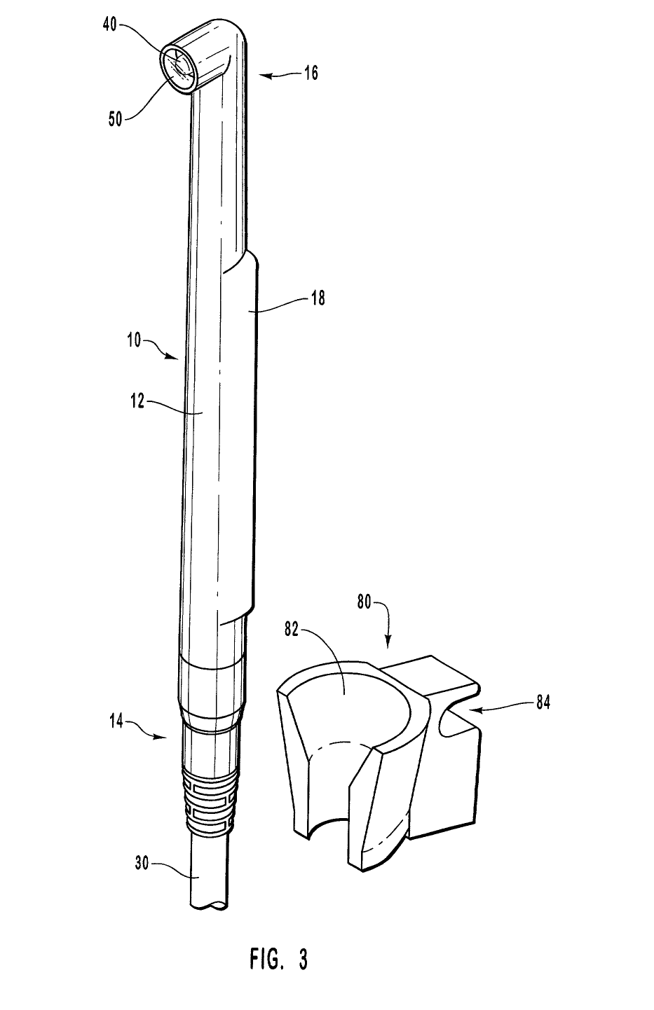

According to one embodiment, the dental device 10 of the invention includes a transilluminating lens 50, as shown in FIGS. 1 and 3-4. The transilluminating lens 50 is preferably color tinted to filter out undesired wavelengths emitted by the light source 40. The transilluminating lens 50 can also function as a shield for protecting the light source 40 from contaminants in the dental environment. As shown in FIG. 1, the lens 50 may be detachable from the distal end 16 of the dental device 10, such as with a snap fitting or a friction fitting, for enabling different types of lenses with different functionality to be interchangeably used with the dental device 10 according to need and preference. Alternatively, as shown in FIG. 3, the lens 50 may be fixedly connected to the distal end 16 of the dental device 10, such as with an adhesive, by welding, or with mechanical coupling.

According to one embodiment, the dental device 10 further includes a heat sink 60 for dissipating heat generated by the light source during use. As shown in FIG. 1, the light source 40 is preferably mounted directly onto the heat sink 60 for enhancing the heat dissipating properties of the heat sink 60 through conduction. The heat sink may comprise any heat conductive materials, such as metal, examples of which include aluminum, copper, brass, steel, silver and combinations of the foregoing.

As shown in FIGS. 1 and 3-4, the light source 40 and the distal end 16 of the dental device 10 are advantageously sized and configured so as to be inserted and rotated within the mouth of a patient. It will be appreciated that this provides an advantage over light curing devices that require special light guides or other protruding and bulky mechanisms to channel the light emitted from a light source into the patient's mouth. In particular, light guides are relatively heavy and protrude away from the light source, thereby increasing the bulkiness of such light curing devices.

Another benefit of the present invention is that the dental device is powered by a remotely located power supply, as mentioned above, which greatly reduces the overall weight of the dental device, thereby increasing the ease of use and ergonomics of the dental device. It will be appreciated, however, that in certain circumstances it may be desirable for the dental device to be configured with an integral power supply, such as a battery. In these circumstances, the dental device may be configured with a battery so long as the body of the dental device remains suitably configured to be held within the holding slot of a dental hand piece holding tray.

According to one embodiment, the dental device also includes controls for controlling the emission of radiant energy from the light source. The controls are advantageously mounted on the body 12 of the dental device 10 for ease of use. By way of example, not limitation, and as shown in FIG. 2, the controls may include three different buttons 70, 72, 74. The first button 70, when depressed, activates the light source 40 for a predetermined duration of time, such as for example 15 seconds. The second and the third buttons 72, 74 can be used to increase or decrease the predetermined duration of time by any desired increment of time, such as for example by 5 second increments. It will be appreciated that this embodiment is useful for at least enabling a dental practitioner to use the dental device 10 without having to continuously depress a button during use. The controls communicate with the power supply wires 15 (FIG. 1) as needed to complete the electrical circuit.

Attention is now directed to FIG. 3. As shown therein, the dental device 10 may be included as part of a kit that further includes a holder 80 configured in size and shape to securely hold the dental device 10 when the proximal end 14 of the dental device 10 is inserted into the holder 80. In particular, the holder 80 includes an inner surface 82 that is sized and configured (e.g., tapered) for frictionally engaging the proximal end 14 of the dental device 10 and for securely holding the dental device 10 in place.

The holder 80 may also include connecting means for connecting the holder 80 with a dental hand piece holding tray or another device or object, such as a counter or shelf. The connecting means can include a recess 84 configured to frictionally engage the edge of a tray, a slot configured to slidably engage a rod, a clamp, an adhesive mounting surface, a screw or bolt and conforming hole formations, and any other suitable means for connecting the holder 80 to a dental hand piece holding tray or other device.

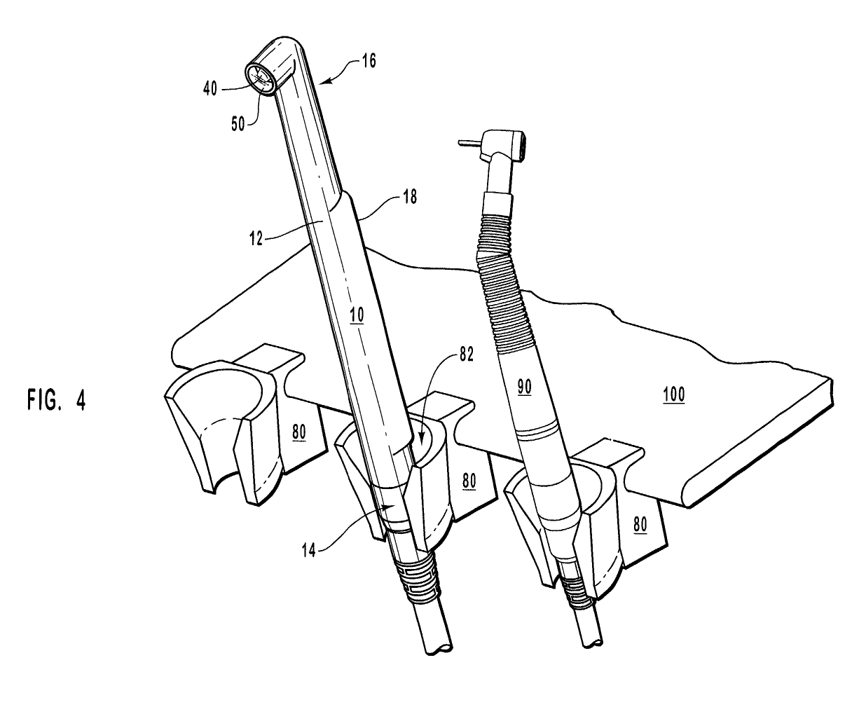

FIG. 4 illustrates how, according to one embodiment, the holder 80 holds the dental device on a dental hand piece holding tray 100. As shown, the dental hand piece holding tray includes several holders or holding slots configured for holding dental hand pieces. An existing turbine hand piece 90 is placed into one of the holders 80 and the dental device of the invention is held within another of the holders 80.

In summary, the dental devices of the invention are configured to have the same general shape, size and weight of conventional dental hand pieces, thereby enabling the dental devices to be securely held within the holders or holding slots of convention dental hand piece holding trays. The dental devices of the invention also include distally located light sources and are powered by remotely located power supplies, which generally eliminates the need for such items as battery packs and light wands, thereby reducing the overall weight and bulk of the dental devices.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A dental device configured for curing light-curable compounds, comprising:
a body extending between a proximal end and a distal end, wherein the proximal end of the body is sized and configured to be received by a dental hand piece holding tray; and
a light source disposed at the distal end of the body and configured to emit radiant energy suitable for curing a light-curable compound.

2. A dental device as recited in claim 1, wherein the light source comprises at least one LED.

3. A dental device as recite din claim 1, further including a power cord operably connecting the dental device to a power supply.

4. A dental device as recited in claim 3, further including power supply wires disposed within the body and communicating between the light source and the power cord.

5. A dental device as recited in claim 1, further comprising controls disposed on the body, wherein the controls are configured for controlling illumination of the light source.

6. A dental device as recited in claim 5, wherein the controls include a first button for activating the light source for a predetermined duration of time.

7. A dental device as recited in claim 6, wherein the controls further include at least one button for altering the predetermined duration of time.

8. A dental device as recited in claim 1, further including at least one battery for supplying power to the light source.

9. A dental device as recited in claim 1, further comprising a transilluminating lens disposed at the distal end of the dental device adjacent to the light source.

10. A dental device as recited in claim 9, wherein the transilluminating lens is configured to filter out undesired wavelengths emitted by the light source.

11. A dental device as recited in claim 9, wherein the transilluminating lens is fixedly connected to the dental device.

12. A dental device as recited in claim 1, wherein dental device further comprises a heat sink.

13. A dental device as recited in claim 12, wherein the light source is mounted on the heat sink.

14. A dental device as recite din claim 12, wherein the he at sink comprises at least one of aluminum, brass, copper, steel or silver.

15. A dental device configured for curing light-curable compounds, comprising:
a body extending between a proximal end and a distal end, wherein the proximal end of the body is configured to securely fit into the holding slot of a standard dental hand piece holding tray, and wherein the distal end of the body is configured in size and shape to be inserted into the mouth of a patient; and
a light source disposed at the distal end of the body configured to emit light suitable for curing light-curable compounds;
a power cord operably connecting the dental device with a remotely located power supply; and
controls disposed on the body configured to control the operation of the light source, wherein the controls are ergonomically disposed on the body to be manipulated by a thumb during use.

16. A dental device as recited in claim 14, wherein the light source comprises an LED.

17. A dental device as recited in claim 14, wherein the body is substantially cylindrical.

18. A dental device as recited in claim 14, further comprising a lens fixedly connected to the distal end of the dental device.

19. A dental kit comprising:
a dental device configured for curing light-curable compounds that includes:
a body extending between a proximal end and a distal end;
a light source disposed at the distal end of the body configured to emit light; and
a power cord operably connecting the dental device with a remotely located power supply;
a holder including:
an inner surface configured in size and shape to frictionally engage the proximal end of the dental device body; and
connecting means for connecting the holder with another device.

20. A dental kit as recited in claim 19, wherein the connecting means is configured for connecting the holder with a standard dental hand piece holding tray.

21. A dental kit as recited in claim 19, wherein the proximal end of the body is cylindrical, and wherein holder defines a slot through which the power cord can freely pass.
